(19) United States
(12) Patent Application Publication
(10) Pub. No.: US 2011/0232075 A1
(43) Pub. Date: Sep. 29, 2011

(54) Wafer holding apparatus and method

(75) Inventor: Toshikazu Yamauchi, Miyazaki (JP)

(73) Assignee: OKI SEMICONDUCTOR CO., LTD., Tokyo (JP)

(21) Appl. No.: 13/064,446

(22) Filed: Mar. 25, 2011

(30) Foreign Application Priority Data
Mar. 26, 2010 (JP) 2010-072609

(51) Int. Cl. B25B 11/00

(52) U.S. Cl. 29/559; 269/21

(57) ABSTRACT

A wafer holding apparatus for holding a wafer in a semiconductor fabrication apparatus includes a stage having a wafer receiving area with a large number of apertures. A gas, supply source supplies gas to the apertures to levitate the wafer by gas pressure. The levitated wafer is held in contact with a retainer disposed above a peripheral part of the wafer receiving area by the gas pressure, which the retainer resists. The wafer is thereby held securely even when the stage is moved, and the surface configuration of the wafer is not affected by the presence of foreign matter between the wafer and stage.

### BACKGROUND OF THE INVENTION

1. Field of the Invention

The present invention relates to a wafer holding apparatus and method.

2. Description of the Related Art

The photoresist exposure procedure in the semiconductor integrated circuit fabrication process generally includes the mounting of a wafer on a stage. If there is foreign matter between the lower surface of the wafer and the upper surface of the stage, the exposure is thrown out of focus; the upper surface of the wafer is pushed above the focal plane by an amount equal to the height of the foreign matter. Where foreign matter is present, accordingly, the pattern transferred onto the photoresist on the upper surface of the wafer is unevenly resolved.

The wafer stages 500 and 520 shown in FIGS. 1 to 3, for example, have been used to solve this problem. FIG. 2 is a sectional view of the wafer stage 500 in FIG. 1 through line A-A. The wafer stage 500 in FIG. 1 has concentric ridges 510. The upper surface of the wafer stage 520 in FIG. 3 has a number of pin-like protrusions. Both of these conventional stages reduce the area of contact between the upper surface of the stage and the lower surface of the wafer, so that even if there is foreign matter on the lower surface of the wafer, the probability of focal displacement is reduced. The probability is not reduced to zero, however, so these solutions are incomplete.

As disclosed by Ono in U.S. Pat. No. 6,333,572 (and Japanese Patent Application Publication No. 10-256355), another solution to the focal displacement problem has been sought by levitating the wafer, either by blowing compressed gas through holes in the surface of the wafer stage from below or by attracting the wafer by electrostatic force from above. Electrostatic and electromagnetic forces are also used to adjust the wafer position. These schemes prevent focal displacement even if foreign matter is present on the lower surface of the wafer, but fail to hold the wafer securely when the stage is moved horizontally for exposure stepping or vertically for focus adjustment. In addition, the electrostatic and electromagnetic forces can adversely affect the electrical characteristics of semiconductor devices formed on the wafer.

### SUMMARY OF THE INVENTION

An object of the present invention is to hold a wafer securely, in such a way that the surface configuration of the wafer is not affected by the presence of foreign matter between the wafer and its mounting stage, without subjecting the wafer to electrostatic or electromagnetic forces.

Another object is to facilitate focus adjustment when the wafer is exposed.

The invention provides a wafer holding apparatus for holding a wafer in a semiconductor fabrication apparatus. The wafer holding apparatus includes a stage having a wafer receiving area. The wafer receiving area includes a plurality of apertures. A gas supply source supplies gas to the apertures to levitate the wafer by gas pressure.

A retainer is disposed above a peripheral part of the wafer receiving area. The levitated wafer is held in contact with the retainer by the gas pressure, which the retainer resists.

The wafer is held securely by physical contact with the retainer, even when the stage is moved.

Since the wafer is levitated from the stage, its surface configuration is not affected by the presence of foreign matter between the wafer and stage.

In the wafer exposure processes, focus can be adjusted globally by adjusting the height of the retainer, and locally by varying the gas pressure in different parts of the wafer receiving area, without moving the stage.

### BRIEF DESCRIPTION OF THE DRAWINGS

In the attached drawings:

FIG. 1 shows a conventional wafer stage;

FIG. 2 is a sectional view through line A-A in FIG. 1;

FIG. 3 shows another conventional wafer stage;

FIG. 4 is a top plan view of the wafer holding apparatus in a first embodiment of the invention;

FIG. 5 is a side view of the wafer holding apparatus of FIG. 4;

FIG. 6 is a sectional view through line A-A in FIG. 4;

FIG. 7 is the side view of the wafer holding apparatus in FIG. 4, together with exposure and imaging units;

FIGS. 8 to 11 are the side views of the wafer holding apparatus in FIG. 4, illustrating steps in the wafer holding procedure;

FIG. 12 is a top view plan illustrating a variation of the wafer retainer in FIG. 4;

FIG. 13 is the top plan view of the wafer holding apparatus in a second embodiment of the invention;

FIG. 14 is a side view of the wafer holding apparatus in FIG. 13;

FIG. 15 is a sectional view through line B-B in FIG. 13;

FIGS. 16 to 20 are the side views of the wafer holding apparatus in FIG. 13, illustrating steps in the wafer holding procedure;

FIG. 21 is a top plan view of the wafer holding apparatus in a third embodiment of the invention;

FIG. 22 is the side view of the wafer holding apparatus in FIG. 21; and

FIG. 23 is a sectional view through line C-C in FIG. 21.

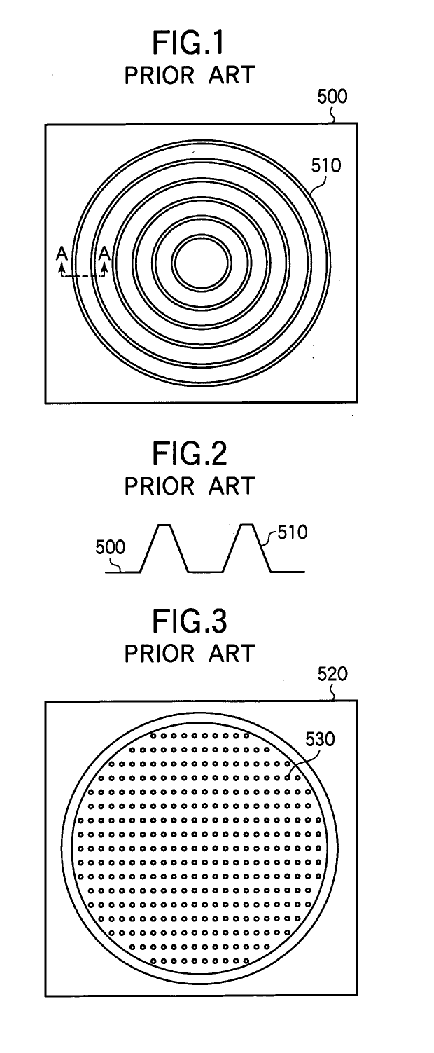

### DETAILED DESCRIPTION OF THE INVENTION

Embodiments of the invention will now be described with reference to the attached drawings, in which like elements are indicated by like reference characters. Where X-Y-Z axes are indicated in the drawings, the X-axis and Y-axis indicate horizontal directions and the Z-axis indicates the vertical direction. Words such as ‘up’, ‘upper’, and ‘above’ refer to the direction of the arrow on the Z-axis. Words such as ‘down’, ‘lower’, and ‘below’ refer to the opposite direction.

### First Embodiment

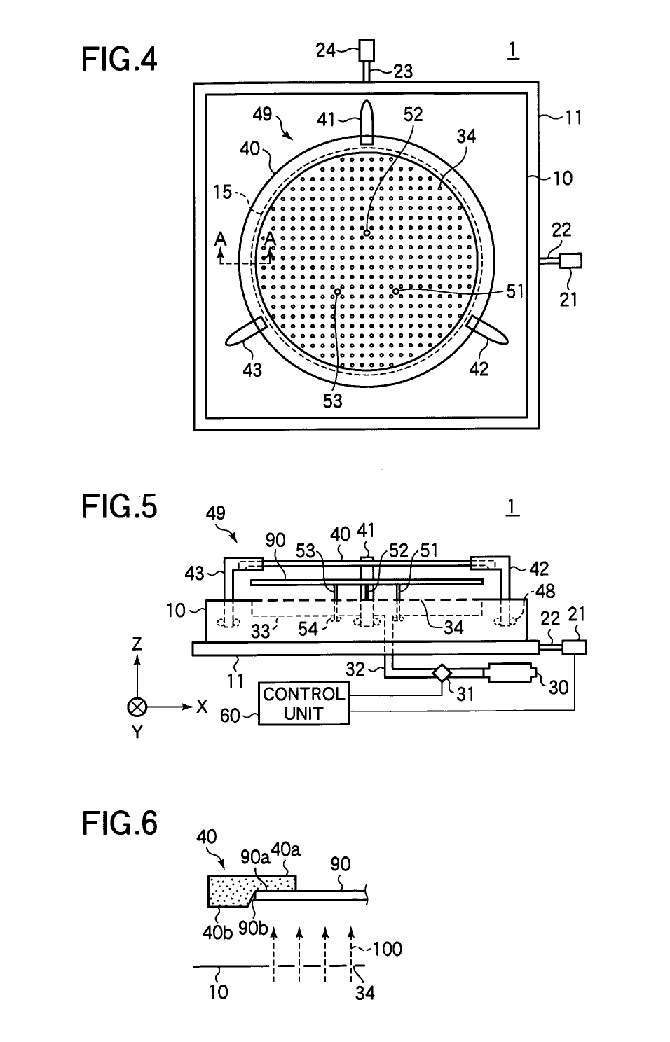

The structure of the wafer holding apparatus in a first embodiment of the invention will be described with reference to FIGS. 4 to 6.

Referring to FIGS. 4 and 5, the wafer holding apparatus 1 includes a stage 10 mounted on a base 11. A wafer 90 is placed on a wafer receiving area 15 in the stage 10 to undergo a photoresist exposure process. The wafer receiving area 15 is a circular area substantially matching the circular shape of the wafer 90. The stage 10 can be moved with respect to the base 11 in the X-axis direction by an X-motor 21 and leadscrew 22, and in the Y-axis direction by a Y-motor 23 and leadscrew 24.

A gas supply source 30 supplies compressed dry air, nitrogen, or another appropriate gas through a flow control valve 31 and gas tube 32 into a flow chamber 33 located just below the surface of the stage 10. The flow rate of the compressed gas is controlled by the flow control valve 31 responsive to flow control commands issued by a control unit 60.

Jets of compressed gas exit the flow chamber 33 through a plurality of small holes or apertures 34 in the wafer receiving area 15 on the surface of the stage 10 to levitate the wafer 90. There is no upper or lower limit on the number of the apertures 34, but the number should be sufficient to levitate the wafer 90. The apertures 34 may be arranged in a grid, as shown, or in a concentric pattern or any other pattern. In order to keep the wafer 90 level, the apertures 34 should be distributed evenly over the entire wafer receiving area 15. The individual apertures 34 may be circular, for example, or may have any other suitable shape.

A ring 40 is supported by supports 41, 42, 43 above the stage 10. The ring 40 and supports 41, 42, 43 constitute the wafer retainer 49. The wafer retainer 49 is located above the periphery of the wafer receiving area 15 and holds the levitated wafer 90 by resisting the pressure of the jets of compressed gas from the apertures 34. The wafer retainer 49 may be made of a metal material such as aluminum, or of various plastic materials or any other suitable material.

The ring 40 is an annular member that holds the outer edge of the wafer 90. In plan view as seen from above the stage 10, the ring 40 overlaps the outer part of the wafer receiving area 15. In cross-sectional view, the ring 40 has the reclining L-shape shown in FIG. 6. The ring 40 includes a horizontal lip 40a with which the peripheral part of the upper surface of the wafer 90 makes contact, and a peripheral flange 40b that extends downward from the outer rim of the ring 40, extending below the lower surface of the horizontal lip 40a. When the wafer 90 is levitated by compressed gas, its peripheral upper edge 90a is held in contact with the lower surface (referred to below as the holding surface) of the horizontal lip 40a. The outer rim 90b of the wafer 90 makes contact with the peripheral flange 40b of the ring 40, preventing movement of the wafer 90 in the horizontal direction (X-Y direction).

The supports 41, 42, 43 rise from the surface of the stage 10 at spaced angular intervals, such as equal intervals of 120 degrees, around the ring 40, and support the ring 40 so that the holding surface of the horizontal lip 40a of the ring 40 is parallel to the surface of the stage 10. The supports 41, 42, 43 have inverted L-shaped cross sections as shown in FIG. 5. The shape and disposition of the supports 41, 42, 43 enable horizontal transfer of the wafer 90 onto the wafer receiving area 15 by use of a wafer transfer arm (not shown).

The supports 41, 42, 43 can be moved perpendicular to the surface of the stage 10 by respective actuators 48 responsive to lifting and lowering commands from the control unit 60. When the wafer 90 is transferred onto the wafer receiving area 15, the supports 41, 42, 43 are lifted to, for example, their full height, which facilitates the horizontal transfer action. When the wafer 90 is held, the supports 41, 42, 43 are lowered, which enables the wafer 90 to be held at a relatively low level, so that the wafer 90 can be held steady by a comparatively low compressed gas pressure.

Supporting pins 51, 52, 53 are recessed in the stage 10 and can be raised by respective actuators 54 so that they extend upward from the surface of the stage 10 as shown in FIG. 5. In this position they provide temporary support for the wafer 90 when the wafer is inserted from the side of the wafer holding apparatus 1. The supporting pins 51, 52, 53 are located at the vertices of a triangle surrounding the center of the wafer receiving area 15. For best support, the triangle is preferably equilateral or approximately equilateral, as shown. The actuators 54 are controlled by raising and lowering commands issued by the control unit 60. The supporting pins 51, 52, 53 are retracted into the stage 10, depositing the wafer 90 on the wafer receiving area 15, before compressed gas is supplied to the flow chamber 33. There may be more than three supporting pins.

The control unit 60 is a microprocessor or the like that controls the operation of the wafer holding apparatus In particular, the control unit 60 adjusts the position of the stage 10 in the horizontal (X and Y) directions by controlling the X- and Y-motors 21, 23 and adjusts the flow rate of the compressed gas by controlling the flow control valve 31.

The stage may also be movable in the Z-axis direction, by a mechanism not shown in the drawings, under the control of the control unit 60.

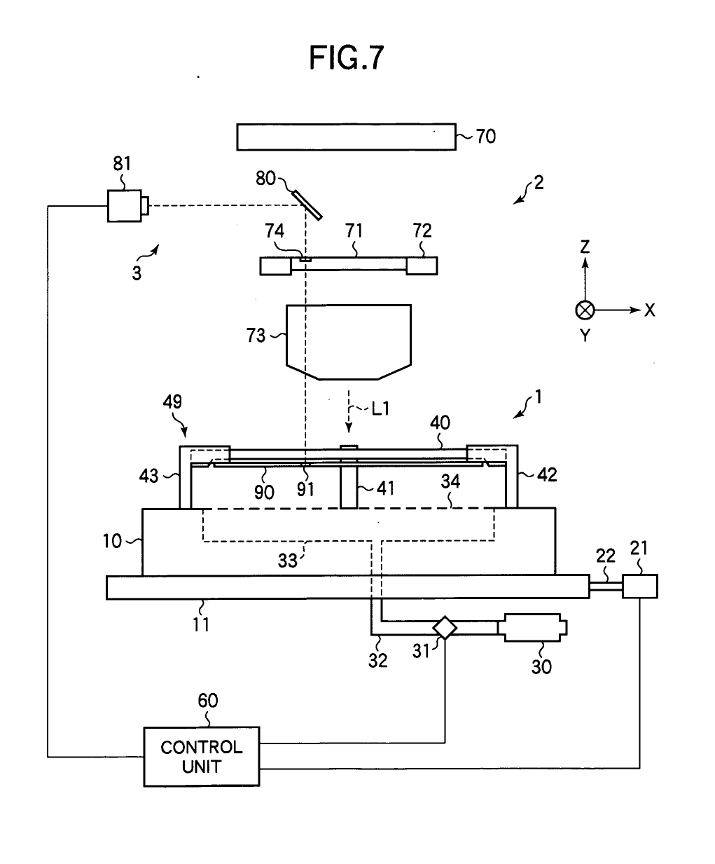

Referring to the side view in FIG. 7, an exposure unit 2 and an imaging unit 3 are disposed above the wafer holding apparatus 1. The exposure unit 2 includes a light source 70, a reticle 71 and its support 72, and a lens 73. The imaging unit 3 includes a mirror 80 and a camera 81.

The light source 70 is a device such as an excimer laser that emits exposure light used to transfer the pattern of the reticle 71 onto the surface of the wafer 90. The reticle 71 is a photomask on which a pattern to be transferred to the surface of the wafer 90 is formed. The reticle 71 is supported below the light source 70 by the support 72. An alignment mark 74 is formed on the reticle 71, for relative positional alignment with the wafer 90. The mask pattern formed by the exposure light that passes through the reticle 71 is reduced by a prescribed reduction ratio by the lens 73, and the reduced mask pattern is projected onto the surface of the wafer 90.

The mirror 80 is supported between the light source 70 and reticle 71, for example, by a supporting member (not shown). The camera 81 captures an image, reflected by the mirror 80, of the alignment mark 74 on the reticle 71 and an alignment mark 91 on the wafer 90, and outputs a corresponding image signal. The control unit 60 receives the image signal, performs image processing, measures the offset between the alignment marks 74, 91, and sends a drive signal to the X-motor 21 to adjust the X-axis position of the stage 10 by an amount corresponding to the offset in the X-direction. In response to the drive signal, the X-motor 21 turns leadscrew 22 to shift the stage 10 by the commanded amount. The Y-axis position of the stage 10 is adjusted similarly by the Y-motor 23.

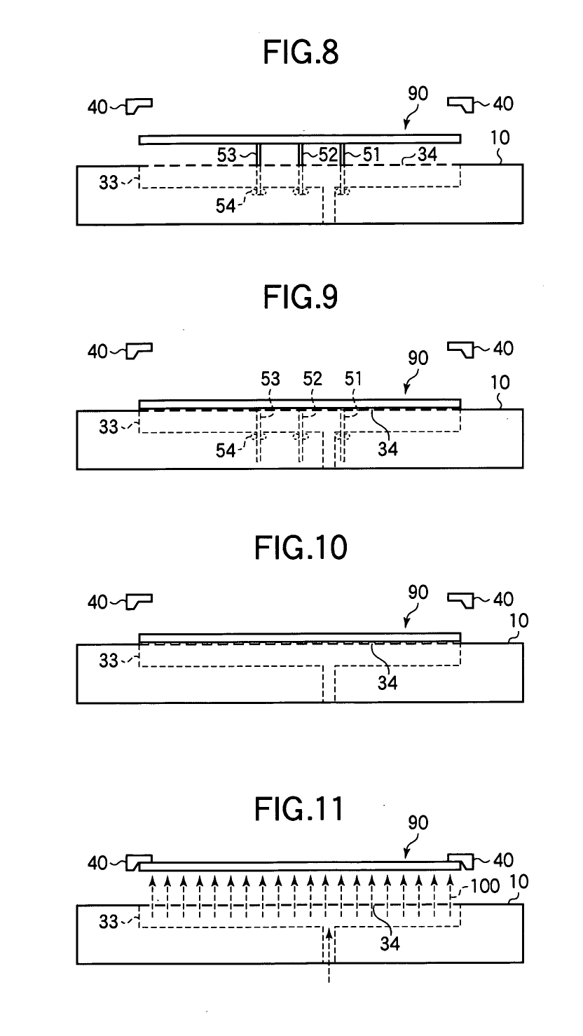

The operation of the wafer holding apparatus 1 in the wafer holding step will now be described with reference to FIGS. 8 to 11. Some of the components described above, such as the base 11 and the supports 41, 42, 43 in FIGS. 4 and 5, are omitted from FIGS. 8 to 11 for clarity. The wafer retainer 49 is indicated only by two cross-sectional portions of the ring 40.

In the initial state, the ring 40 is lifted to an appropriate height above the surface of the stage 10. The lifting is accomplished by the supports 41, 42, 43 and actuators 48 shown in FIG. 5, on command from the control unit 60. The supporting pins 51, 52, 53 are also raised by their actuators 54, responsive to another command from the control unit 60, so that they project above the surface of the stage 10. Sufficient space is left between the level of the lower surface of the ring 40 and the tips of the supporting pins 51, 52, 53 for horizontal insertion of the wafer 90.

In this state, the wafer transfer arm mentioned above inserts the wafer 90 between the lower surface of the ring 40 and the tips of the supporting pins 51, 52, 53, and then lowers the wafer 90 so that it rests on the tips of the supporting pins 51, 52, 53 as shown in FIG. 8.

Next, the supporting pins 51, 52, 53 are lowered by their actuators 54 responsive to yet another command from the control unit 60 and retracted below the surface of the stage 10, so that the wafer 90 rests on the stage 10 as shown in FIG. 9, blocking the apertures 34 in the stage 10.

The ring 40 is then lowered toward the stage 10 as shown in FIG. 10. The lowering is accomplished by actuators 48, which move the supports 41, 42, 43 down in response to still another command from the control unit 60. The ring 40 is lowered to, for example, a level less than a millimeter above the surface of the stage 10, though still high enough not to make contact with the wafer 90.

Next, the gas supply source 30 begins supplying compressed gas to the flow chamber 33. The control unit 60 issues a flow control command to the flow control valve 31 indicating a preset flow rate sufficient to lift the wafer 90 to the level of the ring 40. The corresponding amount of compressed gas flows out through the apertures 34 and lifts the wafer 90, forming a flowspace on the surface of the stage 10. The wafer 90 now floats upward on the flow of compressed gas from the apertures 34, rising until the upper surface of the wafer 90 meets the horizontal holding surface of the ring 40. The wafer 90 is then held as shown in FIG. 11, or in more detail in FIG. 6. The wafer retainer 49 locks the wafer 90 in place by resisting the pressure exerted by the gas 100. The flow of compressed gas 100 from the apertures 34 continues until the exposure process ends. When held in place by the ring 40, the wafer 90 is, for example, a few tens or a few hundreds of micrometers above the surface of the stage 10.

In the photoresist exposure process, a photoresist on the upper surface of the wafer 90 is irradiated with light to transfer the mask pattern onto the surface of the wafer 90. The known step-and-repeat method is used; the exposure is repeated as the mask pattern is stepped across the upper surface of the wafer 90. At each step the stage 10 is shifted horizontally by the X- and/or Y-motors, and the wafer 90 moves together with the stage 10, remaining securely held against the ring 40. For focus adjustment, the control unit may also send commands to the actuators 48 of the supports 41, 42, 43 to raise or lower the ring 40, responsive to focus information generated by, for example, the imaging unit 3. The wafer 90 then moves together with the ring 40 in the Z-axis direction, still held against the ring 40 by gas pressure.

After completion of the photoresist exposure process, the flow of compressed gas is stopped and the wafer 90 floats down onto the upper surface of the stage 10. Next, the supports 41, 42, and 43 are raised to lift the ring 40; then the supporting pins 51, 52, 53 are raised to lift the wafer 90. Finally, the wafer 90 is removed from the wafer holding apparatus 1 by the wafer transfer arm.

Since the wafer holding apparatus 1 in this embodiment has the structure described above, even if there is foreign matter between the lower surface of the wafer 90 and the upper surface of the stage 10, the flatness and level alignment of the upper surface of the wafer 90 are unaffected, and problems of poor focus or poor resolution of the transferred exposure pattern do not occur. Since the wafer retainer 49 holds the wafer 90 securely in a fixed position in relation to the stage 10, the wafer 90 can be moved horizontally for stepping and alignment easily and accurately, by moving the stage 10. Moreover, the focus can be adjusted easily by raising or lowering the supports 41, 42, 43, thereby moving the wafer 90 vertically.

During none of these operation is the wafer 90 subjected to electrostatic or electromagnetic positioning forces. Adverse effects on the electrical characteristics of semiconductor devices formed on the wafer 90 are thus avoided.

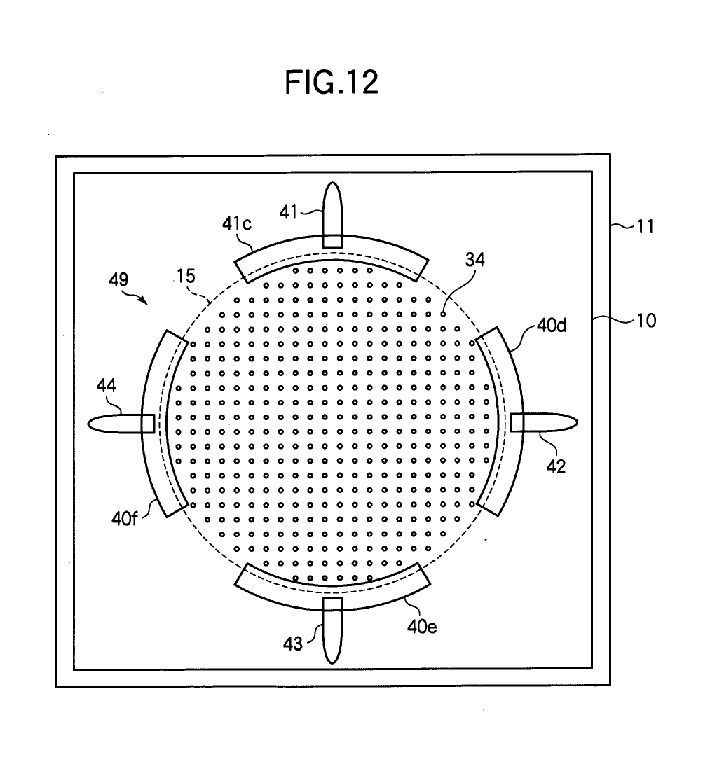

An exemplary variation of the wafer retainer 49 of the wafer holding apparatus 1 is shown in FIG. 12. This wafer retainer 49 has four supports 41, 42, 43, 44 that independently support physically separated ring segments 40c, 40d, 40e, and 40f.

From the viewpoint of supporting the wafer 90 parallel to the surface of the stage 10, the ring 40 preferably has a ring shape matching the outer circumference of the wafer 90, but the supports need not be equally spaced around the^{.} circumference as shown in FIGS. 4 and 12. To maintain maximum parallelism between the surface of the stage 10 and the holding surface (FIG. 6) of the horizontal lip 40a of the ring 40, however, the arrangement shown in FIG. 4, with three supporting members spaced evenly 120 degrees apart, is preferred.

### Second Embodiment

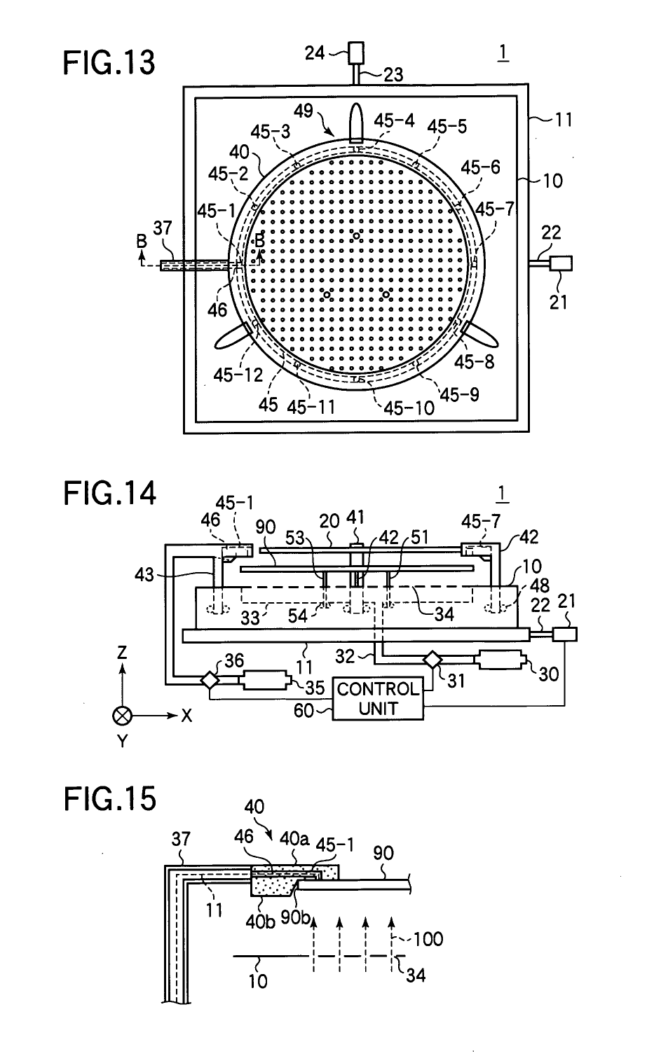

The structure of the wafer holding apparatus 1 in a second embodiment will now be described with reference to FIGS. 13 to 15.

The ring 40 in the second embodiment has an internal vacuum duct 45 linking twelve vacuum apertures 45-1 to 45-12 disposed at equal intervals around the circumference of the ring 40. The vacuum apertures 45-1 to 45-12 open onto the lower (holding) surface of the horizontal lip 40a. The internal vacuum duct 45 is disposed inside the horizontal lip 40a and extends completely around the ring 40. The first vacuum aperture 45-1 is connected through a lead duct 46 to a vacuum pipe 37. Accordingly, the vacuum apertures 45-1 to 45-12 are all connected through the vacuum duct 45 and lead duct 46 to the vacuum pipe 37. The vacuum apertures 45-1 to 45-12, the vacuum duct 45, and the lead duct 46 will also collectively be referred to below as a vacuum channel. The wafer 90 in the second embodiment is securely held against the holding surface of the ring 40 by a partial vacuum formed in the vacuum channel.

The partial vacuum is created by a vacuum pump 35 that evacuates air from the vacuum channel. A flow control valve 36 controls the amount of air evacuated by the vacuum pump 35 responsive to a command from the control unit 60. The vacuum pipe 37 links the vacuum pump 35 with the lead duct 46 in the ring 40.

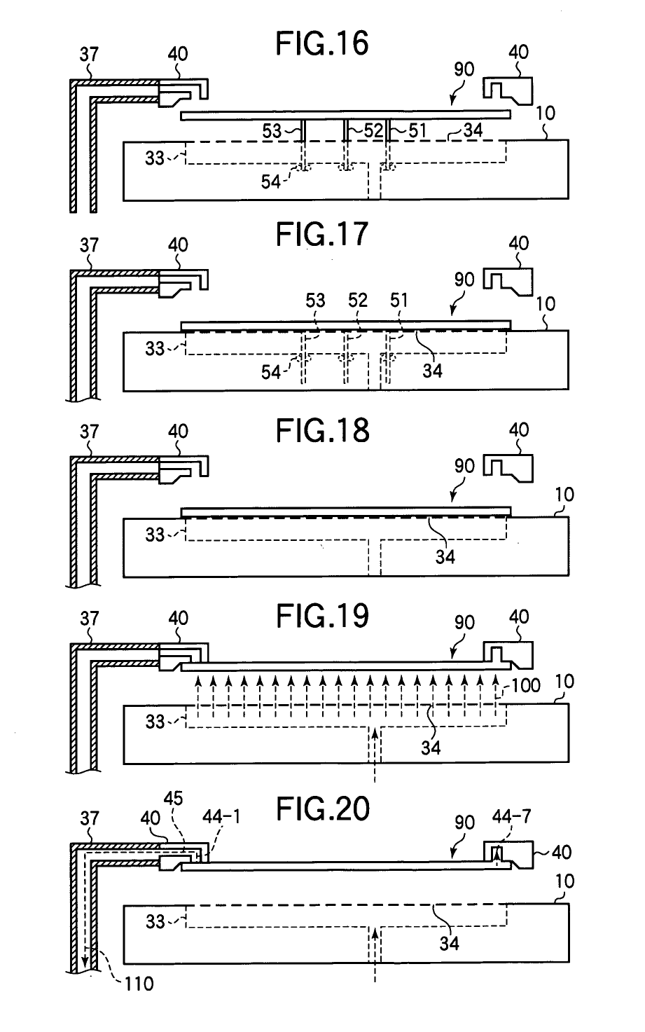

The steps in the wafer holding process carried out by the wafer holding apparatus 1 are illustrated in FIGS. 16 to 20. The steps shown in FIGS. 16 to 19 are identical to the steps in FIGS. 8 to 11 in the first embodiment, so descriptions will be omitted.

When the jets of compressed gas 100 from the apertures 34 have raised the wafer 90 so that its upper outer edge is in contact with the lower surface of the horizontal lip 40a of the ring 40 as shown in FIG. 19, the vacuum pump 35 evacuates air through the vacuum duct 37 as indicated by the arrow 110 in FIG. 20, creating a suction force at the vacuum apertures 45-1 to 45-12 that holds the upper outer edge of the wafer 90 tightly against lower side of the horizontal lip 40a.

This suction force enables the wafer 90 to be held against the ring 40 even more securely than in the first embodiment, ensuring that when the stage 10 is moved in the horizontal (X or Y) direction, the wafer 90 will not move with respect to the ring 40.

As FIG. 20 indicates, once the wafer 90 is gripped by suction force from the vacuum channel, it will remain held against the ring 40 even if the flow of compressed gas is stopped. It is preferable, however, to maintain the flow of compressed gas to support the wafer 90 so that it will not sag under its own weight and its surface will not warp.

The number of the vacuum apertures is not limited to twelve, and the vacuum apertures need not necessarily be disposed at equal intervals.

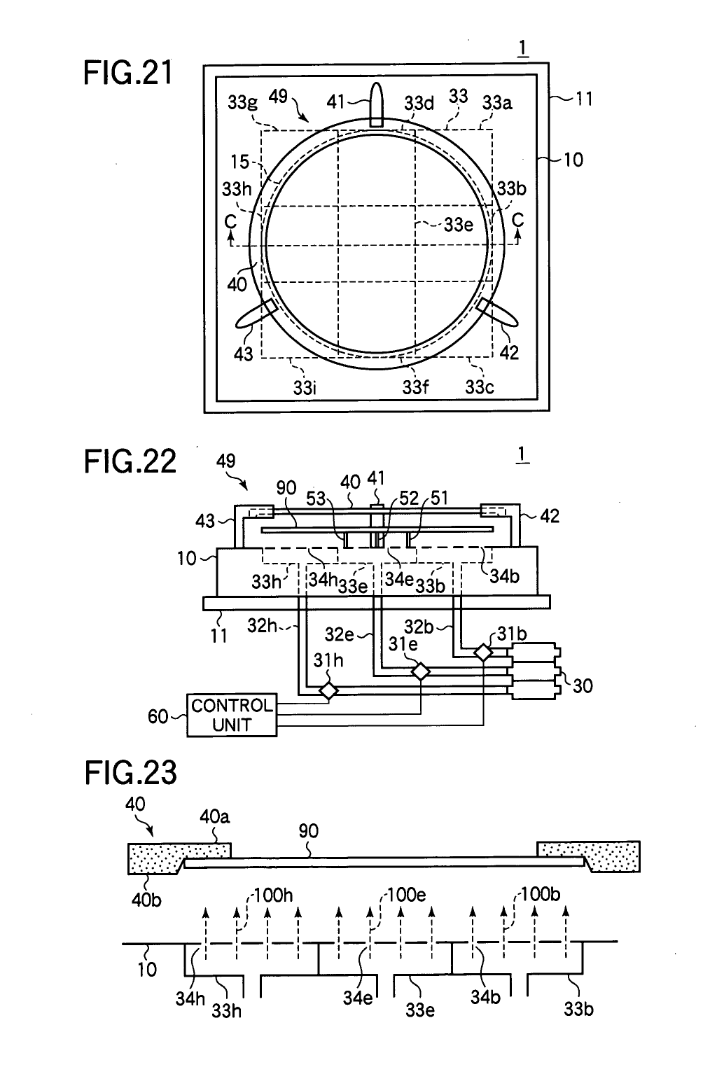

### Third Embodiment The wafer holding apparatus 1 according to a third embodiment will now be described with reference to FIGS. 21 to 23, focusing on the differences from the first embodiment.

The flow chamber 33 in the third embodiment is partitioned into nine sub-chambers 33a to 33i, arranged in three rows and three columns. Each of these sub-chambers 33a to 33i has its own flow control valve (e.g., flow control valve 31b in FIG. 22) and gas tube (e.g., gas tube 32b in FIG. 22). The wafer receiving area 15 consists of nine areas corresponding to the nine chambers. For clarity, the apertures are not shown in FIG. 21, but they are distributed over the entire wafer receiving area 15 as in FIG. 4. Each of the apertures belongs to just one of the nine areas.

The control unit 60 can issue a separate flow control command to each of the flow control valves to control the flow rate of compressed gas (e.g., compressed gas 100b or compressed gas 100e in FIG. 23) from the apertures in the corresponding one of the nine sub-chambers (e.g., sub-chamber 33b or sub-chamber 33e in FIG. 23). The control unit 60 obtains focus information at points corresponding to the centers of each of the sub-chambers 33a to 33i, for example, from a focus detector (not shown), and issues flow control commands to correct differences in focus among the points. For example, if the focal plane above sub-chamber 33e is lower, with respect to the surface of the wafer 90, than the focal plane in other parts of the wafer 90, the control unit 60 issues flow control commands to the flow control valves to make the flow rate into sub-chamber 33e exceed the flow rate into sub-chambers 33a to 33d and 33f to 33i.

The focus detector may be, for example, a conventional oblique incidence focus detector that detects the position of the focal plane by projecting an image onto the wafer 90 and measuring the displacement between the projected and reflected images.

The third embodiment enables the gas flow rate to be varied among different groups of apertures to correct differences in focus at different points on the wafer 90. This permits focus to be controlled with-higher precision than in the preceding embodiments.

The invention is not restricted to the structures shown in the drawings. For example, the number of sub-chambers in the third embodiment is not limited to nine, and they may be arranged in patterns other than the three-by-three pattern shown in FIG. 21.

Those skilled in the art will recognize that further variations are possible within the scope of the invention, which is defined in the appended claims.

What is claimed is:

1. A wafer holding apparatus for holding a wafer in a semiconductor fabrication apparatus, the wafer holding apparatus comprising:
a stage having a wafer receiving area for receiving the wafer, the wafer receiving area including a plurality of apertures;
a gas supply source for supplying gas to the apertures to levitate the wafer by gas pressure; and
a retainer disposed above a peripheral part of the wafer receiving area for resisting levitation of the wafer, the wafer being held against the retainer by pressure of the gas flowing from the plurality of apertures.

2. The wafer holding apparatus of claim 1, wherein the wafer receiving area is substantially identical in shape to the wafer.

3. The wafer holding apparatus of claim 2, wherein the apertures are distributed throughout the wafer receiving area.

4. The wafer holding apparatus of claim 1, wherein the retainer further comprises:
a ring facing at least an outer edge of the wafer receiving area and having a holding surface against which the wafer is held by the gas pressure; and
at least one support for supporting the ring above the stage.

5. The wafer holding apparatus of claim 4, wherein the ring further comprises a flange outwardly peripheral to the holding surface and extending toward the stage.

6. The wafer holding apparatus of claim 4, wherein the ring includes a vacuum channel opening onto the holding surface, the wafer holding apparatus further comprising a vacuum pump for evacuating air from the vacuum channel to hold the wafer against the holding surface by suction force.

7. The wafer holding apparatus of claim 6, wherein the vacuum channel includes a plurality of vacuum apertures, the vacuum channel opening onto the holding surface of the ring through the vacuum apertures.

8. The wafer holding apparatus of claim 1, further comprising a first actuator for moving the retainer toward and away from the stage.

9. The wafer holding apparatus of claim 5, wherein the first actuator moves the retainer in response to focus information.

10. The wafer holding apparatus of claim 1, further comprising:
at least three supporting pins recessably disposed in the wafer receiving area of the stage; and
at least one second actuator for raising and lowering the at least three supporting pins, thereby raising and lowering the wafer without levitation.

11. The wafer holding apparatus of claim 1, wherein the wafer receiving area is divided into a plurality of sub-areas, the wafer holding apparatus further comprising:
a plurality of flow control valves for controlling flow of the gas to the apertures in respective sub-areas of the wafer receiving area; and
a control unit for controlling the flow control valves.

12. The wafer holding apparatus of claim 11, wherein the control unit controls the flow control valves according to focus information.

13. A method of holding a wafer in a semiconductor fabrication apparatus, comprising:
placing the wafer on a stage in the semiconductor fabrication apparatus;
levitating the wafer by supplying a flow of gas through apertures in the stage, thereby causing the wafer to make contact with a retainer disposed above the stage; and
holding the wafer against the retainer by gas pressure by continuing to supply the flow of the gas through the apertures.

14. The method of claim 13, further comprising evacuating air from a vacuum channel in the retainer, thereby also holding the wafer against the retainer by suction force.

15. The method of claim 13, further comprising moving the stage while the wafer is held against the retainer.

16. The method of claim 13, further comprising:
focusing an image onto the levitated wafer;
detecting focus of the image and generating a focus signal; and
moving the retainer in a direction perpendicular to the stage, responsive to the focus signal.

17. The method of claim 13, further comprising:
focusing an image onto the levitated wafer;
detecting focus of the image and generating a focus signal; and
controlling the flow of the gas responsive to the focus signal.

18. The method of claim 17, wherein controlling the flow of the gas further comprises supplying the gas at different flow rates to different groups of the apertures.
